(19) United States
(12) Patent Application Publication
(10) Pub. No.: US 2014/0376141 A1
(43) Pub. Date: Dec. 25, 2014

(54) OVERCURRENT PROTECTION METHOD, CIRCUIT AND INTEGRATED CIRCUIT

(71) Applicant: Fairchild Semiconductor Corporation, San Jose, CA (US)

(72) Inventors: Lei HUANG, Beijing (CN); Na MENG, Beijing (CN)

(21) Appl. No.: 14/313,064

(22) Filed: Jun. 24, 2014

(30) Foreign Application Priority Data
Jun. 24, 2013 (CN) 201310267624.5

(51) Int. Cl. H02H 3/08; H02H 1/00

(52) U.S. Cl. CPC H02H 3/08; H02H 1/0007
USPC 361/101

(57) ABSTRACT

Disclosed is an overcurrent protection method and circuit and an integrated circuit. The overcurrent protection circuit includes an output circuit, an overcurrent sampling circuit and an overcurrent protection loop circuit. The overcurrent sampling circuit is configured to perform overcurrent sampling on the output circuit, and to pass the sampled current to the overcurrent protection loop circuit, and the overcurrent protection loop circuit is configured to perform direct current level shifting on the sampled current to result in a control current, and to provide a negative feedback to the output current of the output circuit based on the control current.

### PRIORITY

The present non-provisional U.S. patent application claims the benefit under 35 U.S.C. §119 of Chinese Patent Application No. 201310267624.5 entitled, “Over Current Protection Method, Circuit and Integrated Circuit” that was originally filed on Jun. 24, 2013. The contents of the above-identified foreign patent application are incorporated herein, in entirety, by reference.

### TECHNICAL FIELD

Among others, the disclosure relates to protection technologies in integrated circuits, and in particular to an overcurrent protection method and circuit and an integrated circuit.

### BACKGROUND

It is typically required to perform overcurrent protection (OCP) on an output circuit of an integrated circuit in order to prevent the integrated circuit from being damaged by an excessive output current. Currently, the output current at the output circuit is generally controlled through a negative feedback of a field effect transistor triggered by an overcurrent-sampled current at the output circuit. In this method, the sampled current, which triggers the negative feedback of the field effect transistor, depends on the performance of the field effect transistor. However, the performance of field effect transistor is easily influenced by temperature and the process. Therefore, this method will significantly impact the accuracy of the overcurrent protection.

### SUMMARY

In view of the above, the disclosure, among others, provides an overcurrent protection method and circuit and an integrated circuit.

In an embodiment, an overcurrent protection circuit is provided, which includes an output circuit, and the overcurrent protection circuit further includes an overcurrent sampling circuit and an overcurrent protection loop circuit. The overcurrent sampling circuit is configured to perform overcurrent sampling on the output circuit, and to pass the sampled current to the overcurrent protection loop circuit. The overcurrent protection loop circuit is configured to perform direct current level shifting on the sampled current to result in a control current, and to provide a negative feedback to the output current of the output circuit based on the control current.

In an embodiment, an overcurrent protection method is provided, in which an overcurrent sampling circuit performs overcurrent sampling on an output circuit, an overcurrent protection loop circuit performs direct current level shifting on the sampled current to result in a control current and

provides a negative feedback to the output current of the output circuit based on the control current.

In an embodiment, an integrated circuit is provided, which includes an overcurrent protection circuit. The overcurrent protection circuit includes an output circuit, an overcurrent sampling circuit and an overcurrent protection loop circuit. The overcurrent sampling circuit is configured to perform overcurrent sampling on the output circuit, and to pass the sampled current to the overcurrent protection loop circuit. The overcurrent protection loop circuit is configured to perform direct current level shifting on the sampled current to result in a control current, and to provide a negative feedback to the output current of the output circuit based on the control current.

According to various embodiments of the disclosure, the overcurrent sampling circuit performs overcurrent sampling on the output circuit and passes the sampled current to the overcurrent protection loop circuit; the overcurrent protection loop circuit performs direct current level shifting on the sampled current to result in a control current, and provides a negative feedback to the output current of the output circuit based on the control current. As such, the control current resulted by direct current level shifting can be used to provide a negative feedback to the output current of the output circuit, thereby preventing the sampled current, which triggers the negative feedback of the field effect transistor from being influenced by the performance of the field effect transistor, as in the prior art, and thus improving the accuracy of the overcurrent protection.

### BRIEF DESCRIPTION OF THE DRAWINGS

FIG. 1 is a schematic diagram of the structure of an NMOS overcurrent protection circuit for protecting an output circuit in the prior art;

FIG. 2 is a schematic diagram of the structure of an overcurrent protection circuit according to an embodiment of the disclosure;

FIG. 3 is a schematic diagram showing the principle of a first NMOS overcurrent protection circuit for protecting an output circuit according to an embodiment of the disclosure;

FIG. 4 is a schematic diagram showing the principle of a second NMOS overcurrent protection circuit for protecting an output circuit according to an embodiment of the disclosure;

FIG. 5 is a schematic diagram showing the principle of a PMOS overcurrent protection circuit for protecting an output circuit according to an embodiment of the disclosure;

FIG. 6 is a simulation diagram of a sampled current I_{ocp} of the overcurrent protection circuit shown in FIG. 1;

FIG. 7 is a simulation diagram of a sampled current I_{ocp} of the overcurrent protection circuit shown in FIG. 3; and

FIG. 8 is a flow chart of an overcurrent protection method according to an embodiment of the disclosure.

### DETAILED DESCRIPTION

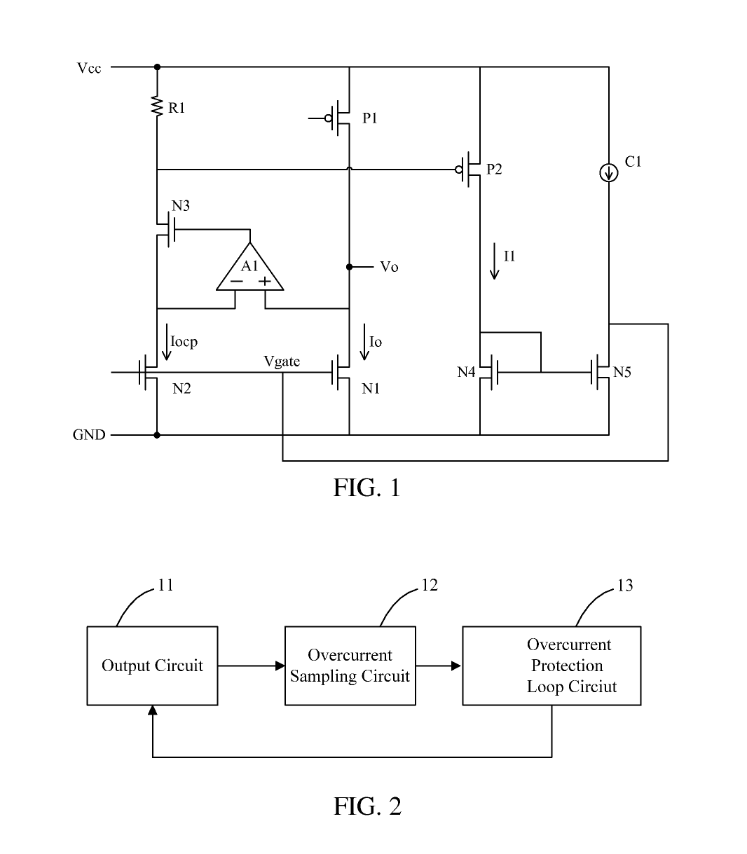

An existing NMOS overcurrent protection circuit for protecting an output circuit is shown in FIG. 1. The overcurrent protection circuit includes: an output circuit consisting of a first PMOS P1 and a first NMOS N1 and having an output voltage Vₒ and an output current Iₒ; an overcurrent sampling circuit for performing overcurrent sampling on the first NMOS N1, and consisting of a first resistor R1, a second NMOS N2, a third NMOS N3 and an amplifier A1; and an overcurrent protection loop circuit consisting of a second PMOS P2, a fourth NMOS N4, a fifth NMOS N5 and a first reference current source C1. When an overcurrent occurs for the output current Iₒ, the sampled current I_{ocp} of the overcurrent sampling circuit increases, which triggers an increase of a gate-source voltage V_{gs1} of the second PMOS P2, an increase of a drain current 11 of the second PMOS P2, and an increase of conductance of the fifth NMOS N5, and a gate voltage V_{gate} of the first NMOS N1 is pulled down by the fifth NMOS N5, and accordingly, the output current Iₒ is also pulled down. As can be seen from FIG. 1, V_{gs1}=I_{ocp}*R1. In other words, I_{ocp}=V_{gs1}/R1. Since the gate-source voltage V_{gs1} of the second PMOS P2, a field effect transistor, may be greatly varied with temperature and process angle, the sampled current I_{ocp} of the overcurrent sampling circuit would also be greatly varied.

According to various embodiments of the disclosure, the overcurrent sampling circuit performs overcurrent sampling on the output circuit and passes the sampled current to the overcurrent protection loop circuit; the overcurrent protection loop circuit performs direct current level shifting on the sampled current to result in a control current, and provides a negative feedback to the output current of the output circuit based on the control current.

The subject matter will be further described in detail with reference to the accompanying drawings and the specific embodiments.

As shown in FIG. 2, an overcurrent protection circuit according to the disclosure includes an output circuit 11, and the overcurrent protection circuit further includes an overcurrent sampling circuit 12 and an overcurrent protection loop circuit 13.

The overcurrent sampling circuit 12 is configured to perform overcurrent sampling on the output circuit 11, and to pass the sampled current to the overcurrent protection loop circuit 13.

The overcurrent protection loop circuit 13 is configured to perform direct current level shifting on the sampled current to result in a control current, and to provide a negative feedback to the output current of the output circuit 11 based on the control current.

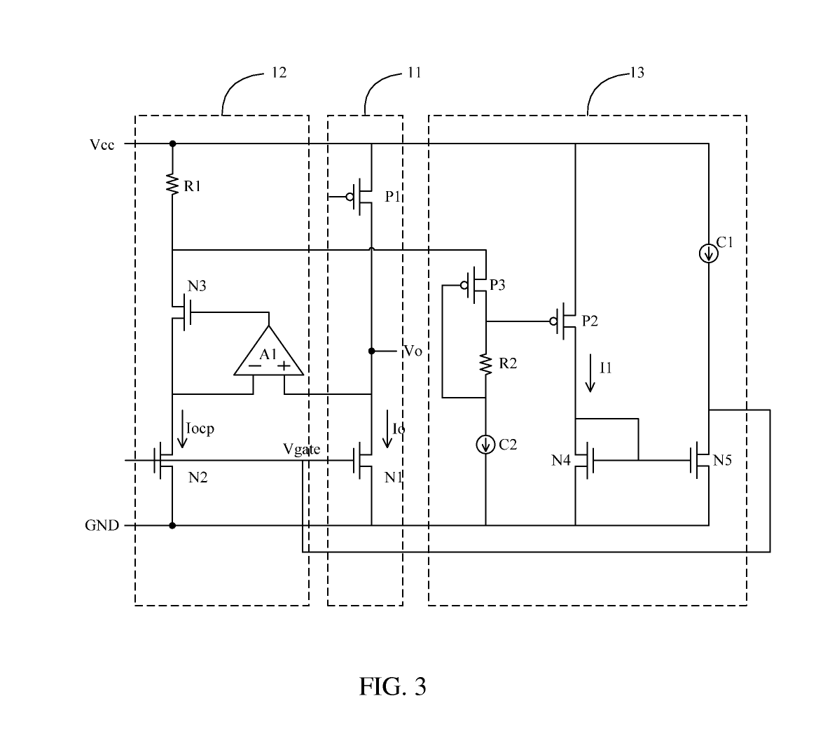

FIG. 3 is a schematic diagram showing the principle of a first NMOS overcurrent protection circuit for protecting an output circuit according to the disclosure. The overcurrent protection circuit includes: an output circuit 11 consisting of a first PMOS P1 and a first NMOS N1 and having an output voltage Vₒ and an output current Iₒ; an overcurrent sampling circuit 12 for performing overcurrent sampling on the first NMOS N1, and consisting of a first resistor R1, a second NMOS N2, a third NMOS N3 and an amplifier A1; and an overcurrent protection loop circuit 13 consisting of a second resistor R2, a second PMOS P2, a third PMOS P3, a fourth NMOS N4, a fifth NMOS N5, a first reference current source C1 and a second reference current source C2.

In the output circuit 11, the source of the first PMOS P1 is connected to a power supply VCC, and the drain of the first PMOS P1 is connected to the drain of the first NMOS N1 and the positive input of the amplifier A1 in the overcurrent sampling circuit 12; the source of the first NMOS N1 is grounded (GND), and the gate of the first NMOS N1 is connected to the gate of the second NMOS N2 in the overcurrent sampling circuit 12 and the drain of the fifth NMOS N5 in the overcurrent protection loop circuit 13.

In the overcurrent sampling circuit 12, the source of the second NMOS N2 is grounded, and the drain of the second NMOS N2 is connected to the negative input of the amplifier A1 and the source of the third NMOS N3; the output of the amplifier A1 is connected to the gate of the third NMOS N3, and the drain of the third NMOS N3 is connected to the source of the third PMOS P3 in the overcurrent protection loop circuit 13, and to the power supply VCC via the first resistor R1.

In the overcurrent protection loop circuit 13, the drain of the third PMOS P3 is connected to the gate of the second PMOS P2 and one end of the second resistor R2, and the gate of the third PMOS P3 is connected to the other end of the second resistor R2 and the second reference current source C2; the source of the second PMOS P2 is connected to the power supply VCC, and the drain of the second PMOS P2 is connected to the drain and gate of the fourth NMOS N4 and the gate of the fifth NMOS N5; the source of the fourth NMOS N4 is grounded (GND); the drain of the fifth NMOS N5 is connected to the gate of the first NMOS N1 in the output circuit 11, and to the power supply VCC via the first reference current source C1, and the source of the fifth NMOS N5 is grounded (GND).

In this embodiment, the third PMOS P3 and the second PMOS P2 are configured with same parameters. In other words, the gate-source voltage V_{gs1} of the second PMOS P2 is equal to the gate-source voltage V_{gs2} of the third PMOS P3.

In the protection circuit, when an overcurrent occurs for the output current Iₒ, the sampled current I_{ocp} of the overcurrent sampling circuit 12 is increased, which pulls down the source voltage of the third PMOS P3, the control current output at the drain of the third PMOS P3 is also pulled down, i.e., the drain current 11 of the second PMOS P2 is increased, and conductance of the fifth NMOS N5 is enhanced, and the gate voltage V_{gate} of the first NMOS N1 is pulled down by the fifth NMOS N5, and accordingly, the output current Iₒ is also pulled down. As can be seen from FIG. 3, the third PMOS P3, the second resistor R2 and the second reference current source C2 form a direct current level shifting circuit such that the following formula is met: I_{ocp}*R1+V_{gs2}=I_{ref}*R2+V_{gs1}, where I_{ref} is the current provided by the second reference current source C2. Since V_{gs1}=V_{gs2}, I_{ocp}*R1=I_{ref}*R2. As such, I_{ocp} only depends on I_{ref}, but does not depend on V_{gs1} or V_{gs2}.

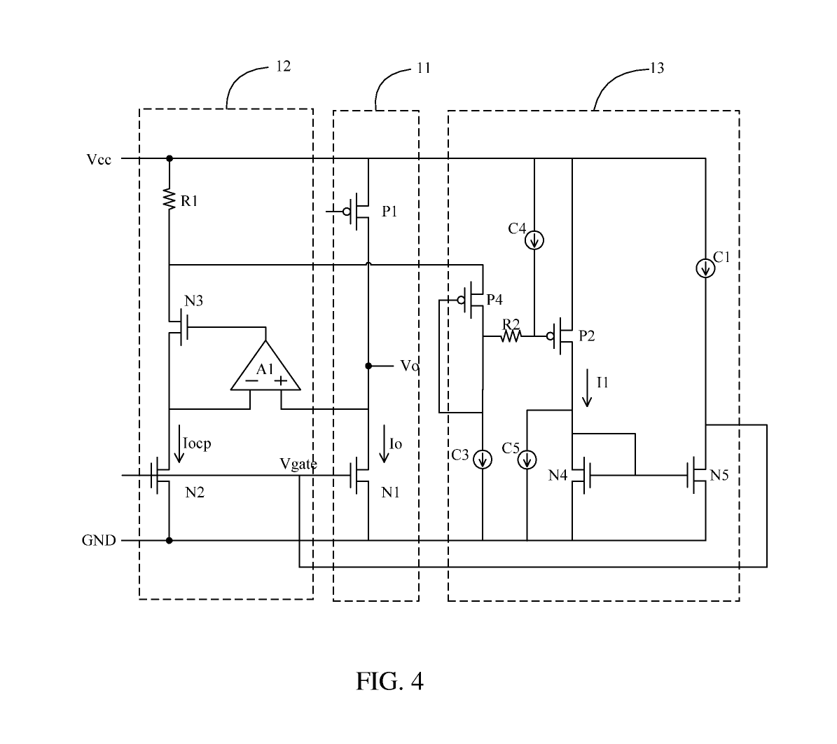

FIG. 4 is a schematic diagram of the principle of a second NMOS overcurrent protection circuit for protecting an output circuit according to the disclosure. The overcurrent protection circuit includes: an output circuit 11 consisting of a first PMOS P1 and a first NMOS N1 and having an output voltage Vₒ and an output current Iₒ; an overcurrent sampling circuit 12 for performing overcurrent sampling on the first NMOS N1, and consisting of a first resistor R1, a second NMOS N2, a third NMOS N3 and an amplifier A1; and an overcurrent protection loop circuit 13 consisting of a third resistor R3, a second PMOS P2, a fourth PMOS P4, a fourth NMOS N4, a fifth NMOS N5, a first reference current source C1, a third reference current source C3 and a fourth reference current source C4.

In the output circuit 11, the source of the first PMOS P1 is connected to a power supply VCC, and the drain of the first PMOS P1 is connected to the drain of the first NMOS N1 and the positive input of the amplifier A1 in the overcurrent sampling circuit 12; the source of the first NMOS N1 is grounded (GND), and the gate of the first NMOS N1 is connected to the gate of the second NMOS N2 in the overcurrent sampling circuit 12 and receives a feedback signal from the overcurrent protection loop circuit 13.

In the overcurrent sampling circuit 12, the source of the second NMOS N2 is grounded (GND), and the drain of the second NMOS N2 is connected to the negative input of the amplifier A1 and the source of the third NMOS N3; the output of the amplifier A1 is connected to the gate of the third NMOS N3, and the drain of the third NMOS N3 is connected to the source of the fourth PMOS P4 in the overcurrent protection loop circuit 13, and to the power supply VCC via the first resistor R1.

In the overcurrent protection loop circuit 13, the source of the PMOS P4 is connected to the drain of the third NMOS N3 in the overcurrent sampling circuit 12, and the drain of the fourth PMOS P4 is connected to the gate of the fourth PMOS P4 and to one end of the third resistor R3 and the third reference current source C3; the gate of the second PMOS P2 is connected to the other end of the third resistor R3 and the fourth reference current source C4; the third reference current source C3 is grounded (GND), and the fourth reference current source C4 is connected to the power supply VCC; the source of the second PMOS P2 is connected to the power supply VCC, and the drain of the second PMOS P2 is connected to the drain and gate of the fourth NMOS N4 and the gate of the fifth NMOS N5; the source of the fourth NMOS N4 is grounded (GND); the drain of the fifth NMOS N5 is connected to the gate of the first NMOS N1 in the output circuit 11, and is connected to the power supply VCC via the first reference current source C1, and the source of the fifth NMOS N5 is grounded (GND).

In this embodiment, the fourth PMOS P4 and the second PMOS P2 are configured with same parameters. In other words, the gate-source voltage V_{gs1} of the second PMOS P2 is equal to the gate-source voltage V_{gs3} of the fourth PMOS P4.

In the protection circuit, when an overcurrent occurs for the output current Iₒ, the sampled current I_{ocp} of the overcurrent sampling circuit is increased, which pulls down the source voltage of the fourth PMOS P4, the control current output at the drain of the fourth PMOS P4 is also pulled down, i.e., the drain current 11 of the second PMOS P2 is increased, and conductance of the fifth NMOS N5 is enhanced, and the gate voltage V_{gate} of the first NMOS N1 is pulled down by the fifth NMOS N5, and accordingly, the output current Iₒ is also pulled down. As can be seen from FIG. 4, the fourth PMOS P4, the third resistor R3 and the third reference current source C3 form a direct current level shifting circuit.

Additionally, in the overcurrent protection circuit shown in FIG. 4, there is a fifth reference current source C5 connected between the source of the second PMOS P2 and the ground.

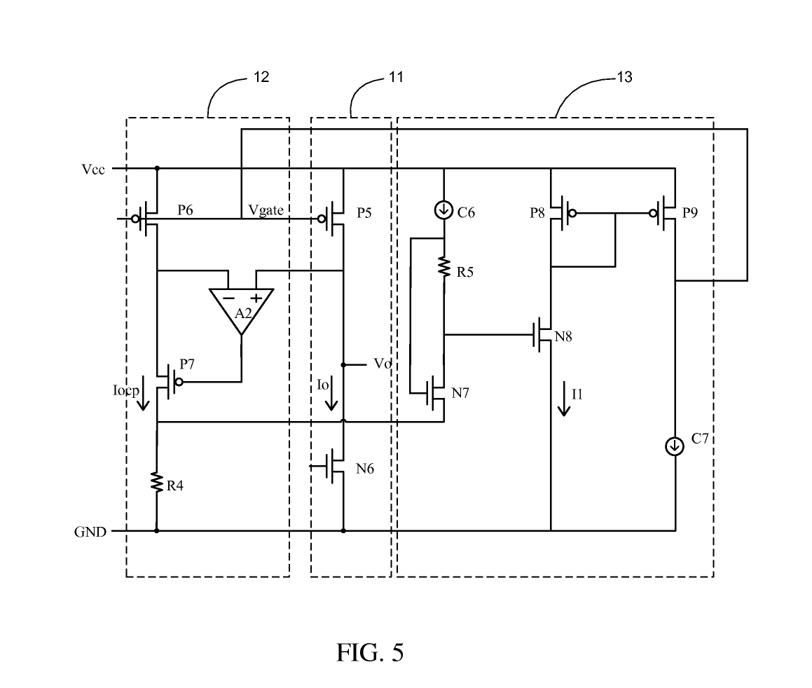

FIG. 5 is a schematic diagram of the principle of a PMOS overcurrent protection circuit for protecting an output circuit according to the disclosure. The overcurrent protection circuit includes: an output circuit 11 consisting a fifth PMOS P5 and a sixth NMOS N6 and having an output voltage Vₒ and an output current Iₒ; an overcurrent sampling circuit 12 performing overcurrent sampling on the fifth PMOS P5, and consisting of a fourth resistor R4, a sixth PMOS P6, a seventh PMOS P7 and an amplifier A2; an overcurrent protection loop circuit 13 consisting of a fifth resistor R5, a seventh NMOS N7, an eighth NMOS N8, an eighth PMOS P8, a ninth PMOS P9, and a sixth reference current source C6, and a seventh reference current source C7.

In the output circuit 11, the source of the fifth PMOS P5 is connected to a power supply VCC, and the gate of the fifth PMOS P5 is connected to the gate of the sixth PMOS P6 in the overcurrent sampling circuit 12 and to the drain of the ninth PMOS P9 in the overcurrent protection loop circuit 13, and the drain of the fifth PMOS P5 is connected to the drain of the sixth NMOS N6 and the positive input of the amplifier A2 of the overcurrent sampling circuit 12; and the source of the sixth NMOS N6 is grounded (GND).

In the overcurrent sampling circuit 12, the source of the sixth PMOS P6 is connected to the power supply VCC, and the drain of the sixth PMOS P6 is connected to the negative input of the amplifier A2 and the source of the seventh PMOS P7; the output of the amplifier A2 is connected to the gate of the seventh PMOS P7; the drain of the seventh PMOS P7 is connected to the source of the seventh NMOS N7 in the overcurrent protection loop circuit 13, and is grounded via the fourth resistor R4.

In the overcurrent protection loop circuit 13, the drain of the seventh NMOS N7 is connected to one end of the fifth resistor R5 and the gate of the eighth NMOS N8, and the gate of the seventh NMOS N7 is connected to the other end of the fifth resistor R5 and the sixth reference current source C6; the sixth reference current source C6 is connected to the power supply VCC; the source of the eighth NMOS N8 is grounded, (GND), and the drain of the eighth NMOS N8 is connected to the drain and gate of the eighth PMOS P8 and the gate of the ninth PMOS P9; the source of the eighth PMOS P8 is connected to the power supply VCC; the drain of the ninth PMOS P9 is connected to the gate of the fifth PMOS P5 in the output circuit 11, and is grounded (GND) via the seventh reference current source C7; the source of the ninth PMOS P9 is connected to the power supply VCC.

In this embodiment, the seventh NMOS N7 and the eighth NMOS N8 are configured with same parameters. In other words, the gate-source voltage V_{gs4} of the seventh NMOS N7 is equal to the gate-source voltage V_{gs5} of the eighth NMOS N8.

In the protection circuit, when an overcurrent occurs for the output current Iₒ, the sampled current I_{ocp} of the overcurrent sampling circuit 12 is increased, which pulls up the source voltage of the seventh NMOS N7, the control current outputted at the drain of the seventh NMOS N7 is pulled down, i.e., the source current 11 of the eighth NMOS N8 is decreased, conductance of the ninth PMOS P9 is enhanced, the gate voltage V_{gate} of the fifth PMOS P5 is pulled up by the ninth PMOS P9 and the output current Iₒ is also pulled down. As can be seen from FIG. 5, the seventh NMOS N7, the fifth resistor R5 and the sixth reference current source C6 form a direct current level shifting circuit.

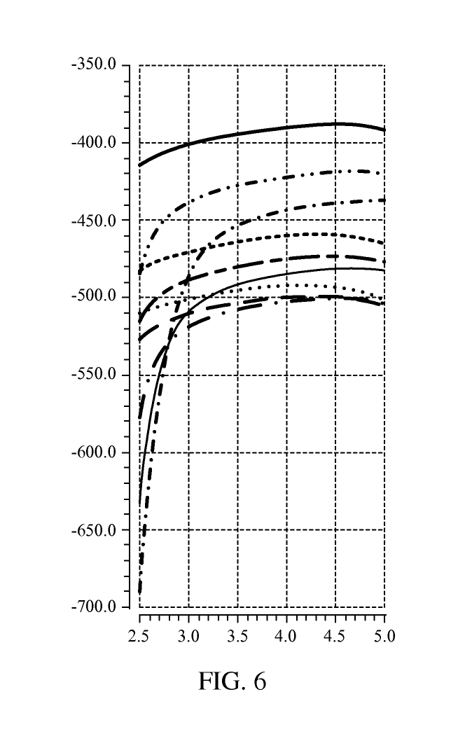

FIG. 6 is a simulation diagram of a sampled current I_{ocp} of the overcurrent protection circuit shown in FIG. 1. FIG. 6 shows curves indicating change of the sampling current I_{ocp} with the power supply VCC at different temperatures and/or at different process corners of the second PMOS P2. As can be seen from FIG. 6, the sampling current I_{ocp} is substantially in a range of 400 mA to 700 mA.

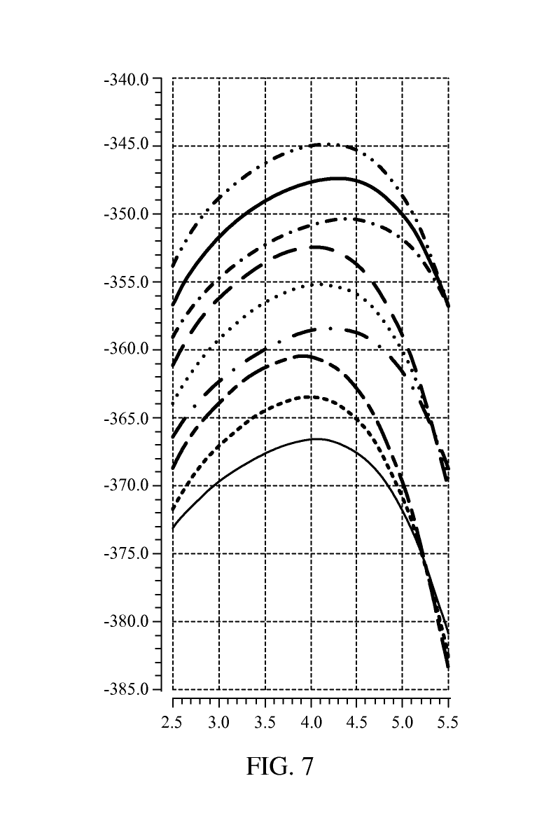

FIG. 7 is a simulation diagram of a sampled current I_{ocp} of the overcurrent protection circuit shown in FIG. 3. FIG. 7 shows curves indicating change of the sampling current I_{ocp} with the power supply VCC at different temperatures and/or at different process corners of the second PMOS P2 and third PMOS P3. As can be seen from FIG. 7, the sampling current I_{ocp} is substantially in a range of 345 mA to 385 mA. Therefore, the accuracy of overcurrent protection is improved significantly.

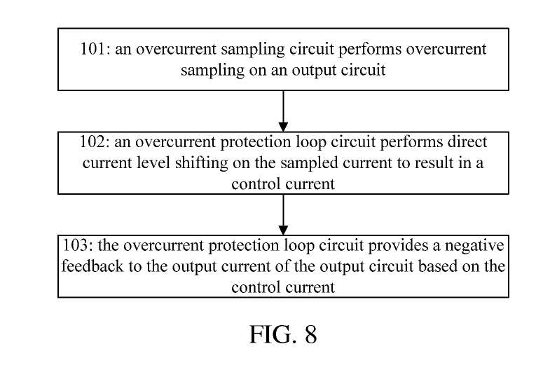

Based on the overcurrent protection circuit, the disclosure further provides an overcurrent protection method. As shown in FIG. 8, the method includes the following steps.

At step 101, an overcurrent sampling circuit performs overcurrent sampling on an output circuit.

At step 102, the overcurrent protection loop circuit performs direct current level shifting on the sampled current to result in a control current.

At step 103, the overcurrent protection loop circuit provides a negative feedback to the output current of the output circuit based on the control current.

Based on the overcurrent protection circuit, the disclosure further provides an integrated circuit, which includes the aforesaid overcurrent protection circuit including an output circuit 11, an overcurrent sampling circuit 12 and an overcurrent protection loop circuit 13.

The overcurrent sampling circuit 12 is configured to perform overcurrent sampling on the output circuit 11, and pass the sampled current to the overcurrent protection loop circuit 13.

The overcurrent protection loop circuit 13 is configured to perform direct current level shifting on the sampled current to result in a control current, and provide a negative feedback to the output current of the output circuit 11 based on the control current.

FIG. 3 is a schematic diagram of the principle of a first NMOS overcurrent protection circuit for protecting an output circuit according to the disclosure. The overcurrent protection circuit includes: an output circuit 11 consisting of a first PMOS P1 and a first NMOS N1 and having an output voltage Vₒ and an output current Iₒ; an overcurrent sampling circuit 12 for performing overcurrent sampling on the first NMOS N1, and consisting of a first resistor R1, a second NMOS N2, a third NMOS N3 and an amplifier A1; and an overcurrent protection loop circuit 13 consisting of a second resistor R2, a second PMOS P2, a third PMOS P3, a fourth NMOS N4, a fifth NMOS N5, a first reference current source C1 and a second reference current source C2.

In the output circuit 11, the source of the first PMOS P1 is connected to a power supply VCC, and the drain of the first PMOS P1 is connected to the drain of the first NMOS N1 and the positive input of the amplifier A1 in the overcurrent sampling circuit 12; the source of the first NMOS N1 is grounded (GND), and the gate of the first NMOS N1 is connected to the gate of the second NMOS N2 in the overcurrent sampling circuit 12 and the drain of the fifth NMOS N5 in the overcurrent protection loop circuit 13.

In the overcurrent sampling circuit 12, the source of the second NMOS N2 is grounded, and the drain of the second NMOS N2 is connected to the negative input of the amplifier A1 and the source of the third NMOS N3; the output of the amplifier A1 is connected to the gate of the third NMOS N3, and the drain of the third NMOS N3 is connected to the source of the third PMOS P3 in the overcurrent protection loop circuit 13, and to the power supply VCC via the first resistor R1.

In the overcurrent protection loop circuit 13, the drain of the third PMOS P3 is connected to the gate of the second PMOS P2 and one end of the second resistor R2, and the gate of the third PMOS P3 is connected to the other end of the second resistor R2 and the second reference current source C2; the source of the second PMOS P2 is connected to the power supply VCC, and the drain of the second PMOS P2 is connected to the drain and gate of the fourth NMOS N4 and the gate of the fifth NMOS N5; the source of the fourth NMOS N4 is grounded (GND); the drain of the fifth NMOS N5 is connected to the gate of the first NMOS N1 in the output circuit 11, and to the power supply VCC via the first reference current source C1, and the source of the fifth NMOS N5 is grounded (GND).

In this embodiment, the third PMOS P3 and the second PMOS P2 are configured with same parameters. In other words, the gate-source voltage V_{gs1} of the second PMOS P2 is equal to the gate-source voltage V_{gs2} of the third PMOS P3.

In the protection circuit, when an overcurrent occurs for the output current Iₒ, the sampled current I_{ocp} of the overcurrent sampling circuit 12 is increased, which pulls down the gate voltage of the third PMOS P3, the control current output at the drain of the third PMOS P3 is also pulled down, i.e., the drain current 11 of the second PMOS P2 is increased, and conductance of the fifth NMOS N5 is enhanced, and the gate voltage V_{gate} of the first NMOS N1 is pulled down by the fifth NMOS N5, and accordingly, the output current Iₒ is also pulled down. As can be seen from FIG. 3, the third PMOS P3, the second resistor R2 and the second reference current source C2 form a direct current level shifting circuit such that the following formula is met: I_{ocp}*R1+V_{gs2}=I_{ref}*R2+V_{gs1}, where I_{ref} is the current provided by the second reference current source C2. Since V_{gs1}=V_{gs2}, I_{ocp}*R1=I_{ref}*R2. As such, I_{ocp} only depends on I_{ref}, but does not depend on V_{gs1} or V_{gs2}.

FIG. 4 is a schematic diagram of the principle of a second NMOS overcurrent protection circuit for protecting an output circuit according to the disclosure. The overcurrent protection circuit includes: an output circuit 11 consisting of a first PMOS P1 and a first NMOS N1 and having an output voltage Vₒ and an output current Iₒ; an overcurrent sampling circuit 12 for performing overcurrent sampling on the first NMOS N1, and consisting of a first resistor R1, a second NMOS N2, a third NMOS N3 and an amplifier A1; and an overcurrent protection loop circuit 13 consisting of a third resistor R3, a second PMOS P2, a fourth PMOS P4, a fourth NMOS N4, a fifth NMOS N5, a first reference current source C1, a third reference current source C3 and a fourth reference current source C4.

In the output circuit 11, the source of the first PMOS P1 is connected to a power supply VCC, and the drain of the first PMOS P1 is connected to the drain of the first NMOS N1 and the positive input of the amplifier A1 in the overcurrent sampling circuit 12; the source of the first NMOS N1 is grounded (GND), and the gate of the first NMOS N1 is connected to the gate of the second NMOS N2 in the overcurrent sampling circuit 12 and receives a feedback signal from the overcurrent protection loop circuit 13.

In the overcurrent sampling circuit 12, the source of the second NMOS N2 is grounded (GND), and the drain of the second NMOS N2 is connected to the negative input of the amplifier A1 and the source of the third NMOS N3; the output of the amplifier A1 is connected to the gate of the third NMOS N3, and the drain of the third NMOS N3 is connected to the source of the fourth PMOS P4 in the overcurrent protection loop circuit 13, and to the power supply VCC via the first resistor R1.

In the overcurrent protection loop circuit 13, the source of the PMOS P4 is connected to the drain of the third NMOS N3 in the overcurrent sampling circuit 12, and the drain of the fourth PMOS P4 is connected to the gate of the fourth PMOS P4 and to one end of the third resistor R3 and the third reference current source C3; the gate of the second PMOS P2 is connected to the other end of the third resistor R3 and the fourth reference current source C4; the third reference current source C3 is grounded (GND), and the fourth reference current source C4 is connected to the power supply VCC; the source of the second PMOS P2 is connected to the power supply VCC, and the drain of the second PMOS P2 is connected to the drain and gate of the fourth NMOS N4 and the gate of the fifth NMOS N5; the source of the fourth NMOS N4 is grounded (GND); the drain of the fifth NMOS N5 is connected to the gate of the first NMOS N1 in the output circuit 11, and is connected to the power supply VCC via the first reference current source C1, and the source of the fifth NMOS N5 is grounded (GND).

In this embodiment, the fourth PMOS P4 and the second PMOS P2 are configured with same parameters. In other words, the gate-source voltage V_{gs1} of the second PMOS P2 is equal to the gate-source voltage V_{gs3} of the fourth PMOS P4.

In the protection circuit, when an overcurrent occurs for the output current Iₒ, the sampled current I_{ocp} of the overcurrent sampling circuit 12 is increased, which pulls down the gate voltage of the fourth PMOS P4, the control current output at the drain of the fourth PMOS P4 is also pulled down, i.e., the drain current 11 of the second PMOS P2 is increased, and conductance of the fifth NMOS N5 is enhanced, and the gate voltage V_{gate} of the first NMOS N1 is pulled down by the fifth NMOS N5, and accordingly, the output current Iₒ is also pulled down. As can be seen from FIG. 4, the fourth PMOS P4, the third resistor R3 and the third reference current source C3 form a direct current level shifting circuit.

Additionally, in the overcurrent protection circuit shown in FIG. 4, there is a fifth reference current source C5 connected between the source of the second PMOS P2 and the ground.

FIG. 5 is a schematic diagram of the principle of a PMOS overcurrent protection circuit for protecting an output circuit according to the disclosure. The overcurrent protection circuit includes: an output circuit 11 consisting a fifth PMOS P5 and a sixth NMOS N6 and having an output voltage Vₒ and an output current Iₒ; an overcurrent sampling circuit 12 performing overcurrent sampling on the fifth PMOS P5, and consisting of a fourth resistor R4, a sixth PMOS P6, a seventh PMOS P7 and an amplifier A2; an overcurrent protection loop circuit 13 consisting of a fifth resistor R5, a seventh NMOS N7, an eighth NMOS N8, an eighth PMOS P8, a ninth PMOS P9, and a sixth reference current source C6, and a seventh reference current source C7.

In the output circuit 11, the source of the fifth PMOS P5 is connected to a power supply VCC, and the gate of the fifth PMOS P5 is connected to the gate of the sixth PMOS P6 in the overcurrent sampling circuit 12 and to the drain of the ninth PMOS P9 in the overcurrent protection loop circuit 13, and the drain of the fifth PMOS P5 is connected to the drain of the sixth NMOS N6 and the positive input of the amplifier A2 of the overcurrent sampling circuit 12; and the source of the sixth NMOS N6 is grounded (GND).

In the overcurrent sampling circuit 12, the source of the sixth PMOS P6 is connected to the power supply VCC, and the drain of the sixth PMOS P6 is connected to the negative input of the amplifier A2 and the source of the seventh PMOS P7; the output of the amplifier A2 is connected to the gate of the seventh PMOS P7; the drain of the seventh PMOS P7 is connected to the source of the seventh NMOS N7 in the overcurrent protection loop circuit 13, and is grounded via the fourth resistor R4.

In the overcurrent protection loop circuit 13, the drain of the seventh NMOS N7 is connected to one end of the fifth resistor R5 and the gate of the eighth NMOS N8, and the gate of the seventh NMOS N7 is connected to the other end of the fifth resistor R5 and the sixth reference current source C6; the sixth reference current source C6 is connected to the power supply VCC; the source of the eighth NMOS N8 is grounded, (GND), and the drain of the eighth NMOS N8 is connected to the drain and gate of the eighth PMOS P8 and the gate of the ninth PMOS P9; the source of the eighth PMOS P8 is connected to the power supply VCC; the drain of the ninth PMOS P9 is connected to the gate of the fifth PMOS P5 in the output circuit 11, and is grounded (GND) via the seventh reference current source C7; the source of the ninth PMOS P9 is connected to the power supply VCC.

In this embodiment, the seventh NMOS N7 and the eighth NMOS N8 are configured with same parameters. In other words, the gate-source voltage V_{gs4} of the seventh NMOS N7 is equal to the gate-source voltage V_{gs5} of the eighth NMOS N8.

In the protection circuit, when an overcurrent occurs for the output current Iₒ, the sampled current I_{ocp} of the overcurrent sampling circuit 12 is increased, which pulls up the source voltage of the seventh NMOS N7, the control current outputted at the drain of the seventh NMOS N7 is pulled down, i.e., the source current 11 of the eighth NMOS N8 is decreased, conductance of the ninth PMOS P9 is enhanced, the gate voltage V_{gate} of the fifth PMOS P5 is pulled up by the ninth PMOS P9, and the output current Iₒ is also pulled down. As can be seen from FIG. 5, the seventh NMOS N7, the fifth resistor R5 and the sixth reference current source C6 form a direct current level shifting circuit.

The descriptions above are just preferred embodiments of the disclosure, but are not intended to limit the scope thereof.

1. An overcurrent protection circuit comprising:
an output circuit;
an overcurrent sampling circuit; and
an overcurrent protection loop circuit;
wherein the overcurrent sampling circuit is configured to perform overcurrent sampling on the output circuit, and to pass the sampled current to the overcurrent protection loop circuit; and
wherein the overcurrent protection loop circuit is configured to perform direct current level shifting on the sampled current to result in a control current, and to provide a negative feedback to the output current of the output circuit based on the control current.

2. The overcurrent protection circuit according to claim 1, wherein the output circuit comprises a first P-channel Metal Oxide Semiconductor Transistor (PMOS) and a first N-channel Metal Oxide Semiconductor Transistor (NMOS);
wherein the overcurrent sampling circuit comprises a first resistor, a second NMOS, a third NMOS and an amplifier; and
wherein the overcurrent protection circuit comprises a second resistor, a second PMOS, a third PMOS, a fourth NMOS, a fifth NMOS, a first reference current source and a second reference current source.

3. The overcurrent protection circuit according to claim 2, wherein in the output circuit, a source of the first PMOS is connected to a power supply, and a drain of the first PMOS is connected to a drain of the first NMOS and a positive input of the amplifier in the overcurrent sampling circuit;
a source of the first NMOS is grounded, and a gate of the first NMOS is connected to a gate of the second NMOS in the overcurrent sampling circuit and a drain of the fifth NMOS in the overcurrent protection loop circuit;
wherein in the overcurrent sampling circuit, a source of the second NMOS is grounded, and a drain of the second NMOS is connected to a negative input of the amplifier and a source of the third NMOS;
an output of the amplifier is connected to a gate of the third NMOS;
a drain of the third NMOS is connected to a source of the third PMOS in the overcurrent protection loop circuit and to the power supply via the first resistor; and
wherein in the overcurrent protection loop circuit, a drain of the third PMOS is connected to a gate of the second PMOS and one end of the second resistor, and a gate of the third PMOS is connected to the other end of the second resistor and the second reference current source;
a source of the second PMOS is connected to the power supply, and a drain of the second PMOS is connected to a drain and a gate of the fourth NMOS and a gate of the fifth NMOS;
a source of the fourth NMOS is grounded;
a drain of the fifth NMOS is connected to the gate of the first NMOS in the output circuit, and to the power supply via the first reference current source; and a source of the fifth NMOS is grounded.

4. The overcurrent protection circuit according to claim 1, wherein the output circuit comprises a first PMOS and a first NMOS;
wherein the overcurrent sampling circuit comprises a first resistor, a second NMOS, a third NMOS and an amplifier; and
wherein the overcurrent protection loop circuit comprises a third resistor, a second PMOS, a fourth PMOS, a fourth NMOS, a fifth NMOS, a first reference current source, a third reference current source and a fourth reference current source.

5. The overcurrent protection circuit according to claim 4, wherein in the overcurrent protection loop circuit, a source of the fourth PMOS is connected to a drain of the third NMOS in the overcurrent sampling circuit, and a drain of the fourth PMOS is connected to a gate of the fourth PMOS and to one end of the third resistor and the third reference current source;
a gate of the second PMOS is connected to the other end of the third resistor and the fourth reference current source;
the third reference current source is grounded, and the fourth reference current source is connected to the power supply;
a source of the second PMOS is connected to the power supply, and a drain of the second PMOS is connected to a drain and a gate of the fourth NMOS and a gate of the fifth NMOS;
a source of the fourth NMOS is grounded;
a drain of the fifth NMOS is connected to the output circuit, and to the power supply via the first reference current source; and
a source of the fifth NMOS is grounded.

6. The overcurrent protection circuit according to claim 1, wherein the output circuit comprises a fifth PMOS and a sixth NMOS;
wherein the overcurrent sampling circuit comprises a fourth resistor, a sixth PMOS, a seventh PMOS and an amplifier; and
wherein the overcurrent protection loop circuit comprises a fifth resistor, a seventh NMOS, an eighth NMOS, an eighth PMOS, a ninth PMOS, a sixth reference current source, and a seventh reference current source.

7. The overcurrent protection circuit according to claim 6, wherein in the output circuit, a source of the fifth PMOS is connected to a power supply, and a gate of the fifth PMOS is connected to a gate of the sixth PMOS in the overcurrent sampling circuit and to a drain of the ninth PMOS in the overcurrent protection loop circuit, a drain of the fifth PMOS is connected to a drain of the sixth NMOS and a positive input of the amplifier in the overcurrent sampling circuit; and
a source of the sixth NMOS is grounded;
wherein in the overcurrent sampling circuit, a source of the sixth PMOS is connected to a power supply, and a drain the sixth PMOS is connected to the negative input of the amplifier and a source of the seventh PMOS;
an output of the amplifier is connected to a gate of the seventh PMOS;
a drain of the seventh PMOS is coupled to a source of the seventh NMOS in the overcurrent protection loop circuit, and is grounded via the four resistor; and
wherein in the overcurrent protection loop circuit, a drain of the seventh NMOS is connected to one end of the fifth resistor and a gate of the eighth NMOS, and a gate of the seventh NMOS is connected to the other end of the fifth resistor and the sixth reference current source;
the sixth reference current source is connected to the power supply;
a source of the eighth NMOS is grounded, and a drain of the eighth NMOS is connected to a drain and a gate of the eighth PMOS and a gate of the ninth PMOS;
a source of the eighth PMOS is connected to the power supply;
a drain of the ninth PMOS is connected to a gate of the fifth PMOS in the output circuit, and is grounded via the seventh reference current source; and
a source of the ninth PMOS is connected to the power supply.

8. An overcurrent protection method, comprising:
performing, by an overcurrent sampling circuit, overcurrent sampling on an output circuit;
performing, by an overcurrent protection loop circuit, direct current level shifting on the sampled current to result in a control current; and
providing a negative feedback to the output current of the output circuit based on the control current.

9. An integrated circuit comprising an overcurrent protection circuit, the overcurrent protection circuit comprising an output circuit, an overcurrent sampling circuit and an overcurrent protection loop circuit;
wherein the overcurrent sampling circuit is configured to perform overcurrent sampling on the output circuit, and to pass the sampled current to the overcurrent protection loop circuit; and
wherein the overcurrent protection loop circuit is configured to perform direct current level shifting on the sampled current to result in a control current, and to provide a negative feedback to the output current of the output circuit based on the control current.

10. The integrated circuit according to claim 9, wherein the output circuit comprises a first PMOS and a first NMOS;
wherein the overcurrent sampling circuit comprises a first resistor, a second NMOS, a third NMOS and an amplifier; and
wherein the overcurrent protection circuit comprises a second resistor, a second PMOS, a third PMOS, a fourth NMOS, a fifth NMOS and a first reference current source, and a second reference current source.

11. The integrated circuit according to claim 10, wherein in the output circuit, a source of the first PMOS is connected to a power supply, and a drain of the first PMOS is connected to a drain of the first NMOS and a positive input of the amplifier in the overcurrent sampling circuit, a source of the first NMOS is grounded, and a gate of the first NMOS is connected to a gate of the second NMOS in the overcurrent sampling circuit and a drain of the fifth NMOS in the overcurrent protection loop circuit;
wherein in the overcurrent sampling circuit, a source of the second NMOS is grounded, and a drain of the second NMOS is connected to a negative input of the amplifier and a source of the third NMOS;
an output of the amplifier is connected to a gate of the third NMOS;
a drain of the third NMOS is couple to a source of the third PMOS in the overcurrent protection loop circuit, and to the power supply via the first resistor; and
wherein in the overcurrent protection loop circuit, a drain of the third PMOS is connected to a gate of the second PMOS and one end of the second resistor, and a gate of the third PMOS is connected to the other end of the second resistor and the second reference current source;
a source of the second PMOS is connected to the power supply, and a drain of the second PMOS is connected to a drain and a gate of the fourth NMOS and a gate of the fifth NMOS;
a source of the fourth NMOS is grounded;
a drain of the fifth NMOS is connected to the gate of the first NMOS in the output circuit, and to the power supply via the first reference current source; and
a source of the fifth NMOS is grounded.

12. The integrated circuit according to claim 9, wherein the output circuit comprises a first PMOS and a first NMOS;
wherein the overcurrent sampling circuit comprises a first resistor, a second NMOS, a third NMOS and an amplifier; and
wherein the overcurrent protection loop circuit comprises a third resistor, a second PMOS, a fourth PMOS, a fourth NMOS, a fifth NMOS, a first reference current source, a third reference current source and a fourth reference current source.

13. The integrated circuit according to claim 12, in the overcurrent protection loop circuit, a source of the fourth PMOS is connected to a drain of the third NMOS in the overcurrent sampling circuit, and a drain of the fourth PMOS is connected to a gate of the fourth PMOS and to one end of the third resistor and the third reference current source;
a gate of the second PMOS is connected to the other end of the third resistor and the fourth reference current source;
the third reference current source is grounded, and the fourth reference current source is connected to the power supply;
a source of the second PMOS is connected to the power supply, and a drain of the second PMOS is connected to a drain and a gate of the fourth NMOS and a gate of the fifth NMOS;
a source of the fourth NMOS is grounded;
a drain of the fifth NMOS is connected to the output circuit, and to the power supply via the first reference current source; and
a source of the fifth NMOS is grounded.

14. The integrated circuit according to claim 9, wherein the output circuit comprises a fifth PMOS and a sixth NMOS;
wherein the overcurrent sampling circuit comprises a fourth resistor, a sixth PMOS, a seventh PMOS and an amplifier; and
wherein the overcurrent protection loop circuit comprises a fifth resistor, a seventh NMOS, an eighth NMOS, an eighth PMOS, a ninth PMOS, a sixth reference current source, and a seventh reference current source.

15. The integrated circuit according to claim 14, wherein in the output circuit, a source of the fifth PMOS is connected to a power supply, and a gate of the fifth PMOS is connected to a gate of the sixth PMOS in the overcurrent sampling circuit and to a drain of the ninth PMOS in the overcurrent protection loop circuit, and a drain of the fifth PMOS is connected to a drain of the sixth NMOS and a positive input of the amplifier in the overcurrent sampling circuit; and
a source of the sixth NMOS is grounded;
wherein in the overcurrent sampling circuit, a source of the sixth PMOS is connected to a power supply, and a drain the sixth PMOS is connected to the negative input of the amplifier and a source of the seventh PMOS;
an output of the amplifier is connected to a gate of the seventh PMOS;
a drain of the seventh PMOS is coupled to a source of the seventh NMOS in the overcurrent protection loop circuit, and is grounded via the four resistor; and
wherein in the overcurrent protection loop circuit, a drain of the seventh NMOS is connected to one end of the fifth resistor and a gate of the eighth NMOS, and a gate of the seventh NMOS is connected to the other end of the fifth resistor and the sixth reference current source;
the sixth reference current source is connected to the power supply;
a source of the eighth NMOS is grounded, and a drain of the eighth NMOS is connected to a drain and a gate of the eighth PMOS and a gate of the ninth PMOS;
a source of the eighth PMOS is connected to the power supply;
a drain of the ninth PMOS is connected to a gate of the fifth PMOS in the output circuit, and is grounded via the seventh reference current source; and
a source of the ninth PMOS is connected to the power supply.
